(19) United States
(12) Patent Application Publication
(10) Pub. No.: US 2011/0043171 A1
(43) Pub. Date: Feb. 24, 2011

(54) POWER GENERATION CONTROL DEVICE, VEHICLE EQUIPPED WITH POWER GENERATION CONTROL DEVICE, AND POWER GENERATION CONTROL METHOD

(75) Inventor: Hisao Niwa, Nagoya-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi, Aichi-ken (JP)

(21) Appl. No.: 12/740,201

(22) PCT Filed: Oct. 31, 2008
(86) PCT No.: PCT/IB08/02921

§ 371 Date: Apr. 28, 2010

(30) Foreign Application Priority Data
Nov. 2, 2007 (JP) 2007-286346

(51) Int. Cl. H02P 9/10

(52) U.S. Cl. 322/59

(57) ABSTRACT

A power generation controller for controlling a power generation voltage of a generator; the power generation controller including a warning unit that warns about a start of a high-power load, a power generation voltage setting unit that sets a target of the power generation voltage of the generator and switches the target from a first voltage corresponding to a normal-power load to a second voltage that is higher than the first voltage when a warning is received from the warning unit, and an excitation current controller that controls an excitation current of the generator so that the power generation voltage of the generator becomes the first voltage when the target is the first voltage, and controls the excitation current of the generator so that the power generation voltage of the generator becomes the second voltage when the target is switched to the second voltage.

### BACKGROUND OF THE INVENTION

1. Field of the Invention

This invention relates to a power generation control device, a vehicle equipped with the power generation control device, and a power generation control method. More particularly, this invention relates to a power generation control device that prevents the output voltage of a generator and a positive electrode terminal voltage of a battery from decreasing and prevents electronic devices and the like from malfunctioning when a high-power load is started, and relates to a vehicle equipped with the power generation control device, and a power generation control method.

2. Description of the Related Art

The output voltage control of a generator such as an alternator has been performed by controlling the excitation current with a switching regulator. A generator installed on an automobile supplies power to a normal-power load and a high-power load that consumes more power than the normal-power load. The normal-power load in an automobile is a power load that does not uses an electric motor, for example, a display or a communication device. The high-power load in an automobile is a load that instantaneously consumes high power due to a rush current, such as an electric motor used for electric power steering (EPS).

In some cases the output voltage of a generator in an automobile is controlled to a value (usually, 12.5 to 14.5 V) corresponding to a normal-power load and is not controlled to a value corresponding to a high-power load. Where no control is performed to a value corresponding to a high-power load, when the high-power load is started, the output voltage of a generator and a positive electrode terminal voltage of a battery rapidly drop and it is possible that electronic components will malfunction.

According to the invention described in Japanese Patent Application Publication No. 5-77680 (JP-A-5-77680), the devices consuming electric power are divided into a group of a high order of priority and a group of a low order of priority, the sum total of power consumed in the group of a high order of priority and the group of a low order of priority is found, and when the sum total exceeds the allowed power of power supply means, the power is preferentially supplied to the group of a high order of priority and the remaining power is supplied to the group of a low order of priority.

In accordance with the invention described in JP-A-5-77680, when power consumption is too high, the power is preferentially supplied to devices of a high order of priority and functional deterioration of the devices can be prevented. However, when power consumption is too high, functional deterioration of devices of a low order of priority is difficult to avoid.

### SUMMARY OF THE INVENTION

It is an object of the invention to provide a power generation control device that can prevent the output voltage of a generator and a positive electrode terminal voltage of a battery from decreasing and electronic devices and the like from malfunctioning when a high-power load is started, a vehicle equipped with the power generation control device, and a power generation control method.

The first aspect of the invention relates to a power generation control device. The power generation control device controls a power generation voltage of a generator that supplies power to a normal-power load and a high-power load that consumes more power than the normal-power load. The power generation control device includes a start warning unit that warns about a start of the high-power load; a power generation voltage setting unit that sets a target value of the power generation voltage of the generator and switches the target value from a first voltage corresponding to the normal-power load to a second voltage that is higher than the first voltage when a warning is received from the start warning unit; and an excitation current control unit that controls an excitation current of the generator so that the power generation voltage of the generator becomes the first voltage when the target voltage is the first voltage, and controls the excitation current of the generator so that the power generation voltage of the generator becomes the second voltage when the target value is switched to the second voltage.

With the power generation control device, where the start warning unit warns about the start of the high-power load and the power generation voltage setting unit receives the warning from the start warning unit, the power generation voltage setting unit switches the target value of the power generation voltage to a value for the high-power load. The excitation current control unit performs the excitation current control correspondingly to this switching. As a result, the power generation voltage can be raised to a value higher than the value corresponding to the normal-power load before the high-power load is started, and electronic devices and the like can be prevented from malfunctioning when the high-power load is started.

The excitation current control unit may include a switching regulator for controlling the excitation current, and when the target value is switched to the second voltage, the switching regulator may set a duty ratio to 1 till the power generation voltage becomes the second voltage.

The generator performs power generation at full power generation capacity as long as the duty ratio of the switching regulator is 1. Therefore, the generator can rapidly increase the power generation voltage to the second voltage.

The second voltage may be a rated voltage of a component receiving the power generation voltage.

By making the second voltage equal to the rated voltage of a component receiving the power generation voltage, it is possible to increase the power generation voltage to a maximum limit voltage at which no breakdown occurs in the component. Therefore, the power generation voltage can be increased to a maximum possible value within a range in which no adverse effect is produced on the entire system receiving power supply from the generator.

The excitation current control unit may make the duty ratio less than 1 when the power generation voltage becomes the second voltage and may control the excitation current of the generator so that the power generation voltage does not exceed the second voltage.

The second aspect of the invention relates to a power generation control device. The power generation control device controls a power generation voltage of a generator that supplies power to a power load. The power generation control device includes: a start warning unit that warns about a start of the power load; a power generation voltage setting unit that sets a target value of the power generation voltage of the generator and switches the target value from a first voltage that is lower than a positive electrode terminal reference voltage of a battery connected to the generator to a second voltage that is higher than the positive electrode terminal reference voltage when a warning is received from the start warning unit; and an excitation current control unit that controls an excitation current of the generator so that the generator does not perform power generation when the target value is the first voltage and also controls an excitation current of the generator so that the power generation voltage of the generator becomes the second voltage when the target value is switched to the second voltage.

With this power generation control device, where the start warning unit warns about the start of the power load and the power generation voltage setting unit receives the warning from the start warning unit, the power generation voltage setting unit switches the target value of the power generation voltage to a second voltage that is higher than the positive electrode terminal reference voltage of the battery. The excitation current control unit performs the excitation current control correspondingly to this switching. As a result, for example, even when the generator installed on the automobile stops power generation when the automobile accelerates, the generator can immediately start power generation in response to the warning about the start of the power load and can generate power of a voltage higher than the positive electrode terminal voltage of the battery before the power load is started. As a result, electronic devices and the like can be prevented from malfunctioning when the high-power load is started. What is referred to as “power load” include the abovementioned normal-power load and high-power load.

The excitation current control unit may include a switching regulator for controlling the excitation current, and when the target value is switched to the second voltage, the switching regulator may set a duty ratio to 1 till the power generation voltage becomes the second voltage.

The third aspect of the invention relates to a vehicle equipped with the power generation control device according to the first aspect. The vehicle has an acceleration state detection unit that detects an acceleration state of the vehicle. The power generation voltage setting unit sets a voltage at the time the acceleration state detection unit detects that the vehicle is in an acceleration state to a lower limit value of the first voltage and sets a voltage at the time the acceleration state detection unit detects that the vehicle is in a deceleration state to an upper limit value of the first voltage.

The fourth aspect of the invention relates to a vehicle with the power generation control device according to the first aspect and second aspect. The vehicle has an acceleration state detection unit that detects an acceleration state of the vehicle. The excitation current control unit controls the excitation current of the generator to zero when the acceleration state detection unit detects that the vehicle is in the acceleration state and the start Warning unit does not warn about the start of the high-power load.

The fifth aspect of the invention relates to a method for controlling a power generation voltage of a generator. This method controls the power generation voltage of a generator that supplies power to a normal-power load and a high-power load that consumes more power than the normal-power load. The method includes warning about a start of the high-power load, switching a target value of the power generation voltage of the generator from a first voltage corresponding to the normal-power load to a second voltage that is higher than the first voltage when a warning about the start of the high-power load is issued, controlling an excitation current of the generator so that the power generation voltage of the generator becomes the first voltage when the target voltage is the first voltage, and controlling an excitation current of the generator so that the power generation voltage of the generator becomes the second voltage when the target value is switched to the second voltage.

The sixth aspect of the invention relates to a method for controlling a power generation voltage of a generator that supplies power to a power load. The method includes: warning about a start of the high-power load; setting a target value of the power generation voltage of, the generator; switching the target value for generator power transmission from a first voltage that is lower than a positive electrode terminal reference voltage of a battery connected to the generator to a second voltage that is higher than the positive electrode terminal reference voltage; and controlling an excitation current of the generator so that the generator does not perform power generation when the target value is the first voltage and also controlling an excitation current of the generator so that the power generation voltage of the generator becomes the second voltage when the target value is switched to the second voltage.

The invention can provide a power generation control device that can prevent the output voltage of a generator and a positive electrode terminal voltage of a battery from decreasing and electronic devices and the lice from malfunctioning when a high-power load is started, a vehicle equipped with the power generation control device, and a power generation control method.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 shows the configuration of the power generation control device of the first embodiment;

FIG. 2 is a flowchart illustrating the operation of the power generation control device of the first embodiment;

FIG. 3 shows how the output terminal voltage of a generator is changed by the operation of the power generation control device of the first embodiment;

FIG. 4 shows the configuration of the power generation control device of the second embodiment;

FIG. 5 is a flowchart illustrating the operation of the power generation control device of the second embodiment; and

FIG. 6 shows how the output terminal voltage of a generator is changed by the operation of the power generation control device of the second embodiment.

### DETAILED DESCRIPTION OF EMBODIMENTS

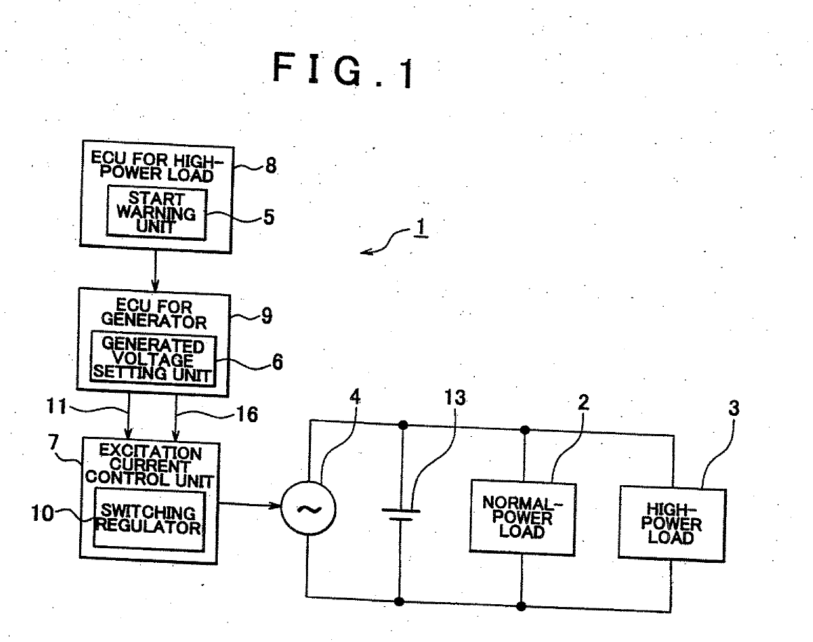

A power generation control device of the first embodiment of the invention will be described below with reference to the appended drawings. FIG. 1 illustrates the configuration of the power generation control device of the first embodiment.

The power generation control device 1 of the first embodiment controls a power generation voltage of a generator 4 that supplies power to both a normal-power load 2 and a high-power load 3 that consumes a power higher than that consumed by the normal-power load 2. The generator 4 is, for example, an alternator. A battery 13 is connected to the generator 4. The power generation control device 1 mainly can be applied to an automobile. In the explanation below, a case in which the power generation control device 1 is applied to an automobile will be described.

The normal-power load 2 is for example a power load that does not use an electric motor, for example, a display or a communication device. The high-power load 3 is, for example, a power load that uses an electric motor, more particularly a load that instantaneously consumes a high power by a rush current, such as an electric motor employed for EPS or electronic control brake system (ECB).

The power generation control device 1 includes a start warning unit 5, a power generation voltage setting unit 6, and an excitation control unit 7.

The start warning unit 5 warns about the start of the high-power load 3. In the example shown in FIG. 1, the start warning unit 5 is provided in an ECU 8 for a high-power load that controls the high-power load 3. When a user issues a command to start the high-power load 3, more specifically, for example, when a steering operation is started in an EPS mode, the start warning unit 5 outputs a start warning signal before the high-power load 3 is started. The start warning signal is inputted in the power generation voltage setting unit 6.

The power generation voltage setting unit 6 sets a target value of the power generation voltage of the generator 4. In the example shown in FIG. 1, the power generation voltage setting unit 6 is provided in an ECU 9 for a generator that controls the generator 4. When the power generation voltage setting unit 6 receives a start warning signal from the start warning unit 5, the power generation voltage setting unit switches the target value from a first voltage V1 (for example, 12.5 to 14.5 V) corresponding to the normal-power load 2 to a second voltage V2 (for example, 16 V) that is higher than the first voltage. When the target value of the power generation voltage is the first voltage VI, the power generation voltage setting unit 6 outputs a signal indicating the value of the first voltage V1 to the excitation current control unit 7, for example, by serial communication 11. When the target value of the power generation voltage is switched from the first voltage V1 to the second voltage V2, the power generation voltage setting unit 6 outputs a signal (referred to hereinbelow as “V2 switching signal”) indicating the switching of the power generation voltage by high-speed communication 16 to the excitation current control unit 7. Specific means of high-speed communication 16 is not limited. For example, parallel communication or communication that indicates the switching by a one-bit signal may be employed. By sending the V2 switching signal by such high-speed communication 16, the switching indication can be performed rapidly. As a result, the power generation voltage can be rapidly switched to the second voltage V2.

The first voltage V1 can be provided with the above-described range (for example, 12.5 to 14.5 V). When a range is provided, the lower limit value thereof is a voltage corresponding to a power generation cut during automobile acceleration, and the lower limit value of the range is a voltage corresponding to positive power generation by power regenerative braking during automobile deceleration.

The second voltage V2 is preferably a rated voltage of a component receiving the power generation voltage. By making the second voltage V2 equal to the rated voltage (for example, 16 V) of a component receiving the power generation voltage, it is possible to increase the power generation voltage to a maximum limit voltage at which no breakdown occurs in the component. Therefore, the power generation voltage can be increased to a maximum possible value within a range in which no adverse effect is produced on the entire system receiving power supply from the generator 4.

The excitation current control unit 7 controls the excitation current of the generator 4 so that the power generation voltage of the generator 4 becomes the first voltage V1 when the target value of the power generation voltage is the first voltage V1. The excitation current control unit 7 controls the excitation current of the generator 4 so that the power generation voltage of the generator 4 becomes the second voltage V2 when the target value is switched to the second voltage V2.

The excitation current control unit includes a switching regulator 10 for controlling the excitation current. When the target value of the power generation voltage is switched to the second voltage V2, the switching regulator 10 preferably sets the duty ratio to 1 till the power generation voltage becomes the second voltage V2. As long as the duty ratio of the switching regulator 10 is 1, the generator 4 generates power at full power generation capacity. Therefore, the generator 4 can rapidly increase the power generation voltage to the second voltage V2.

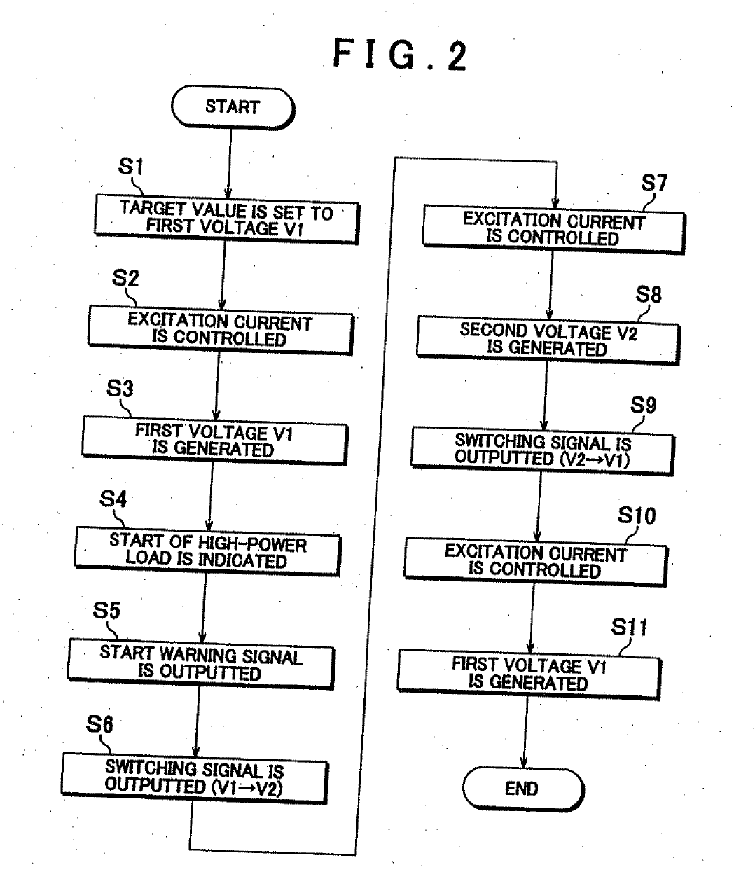

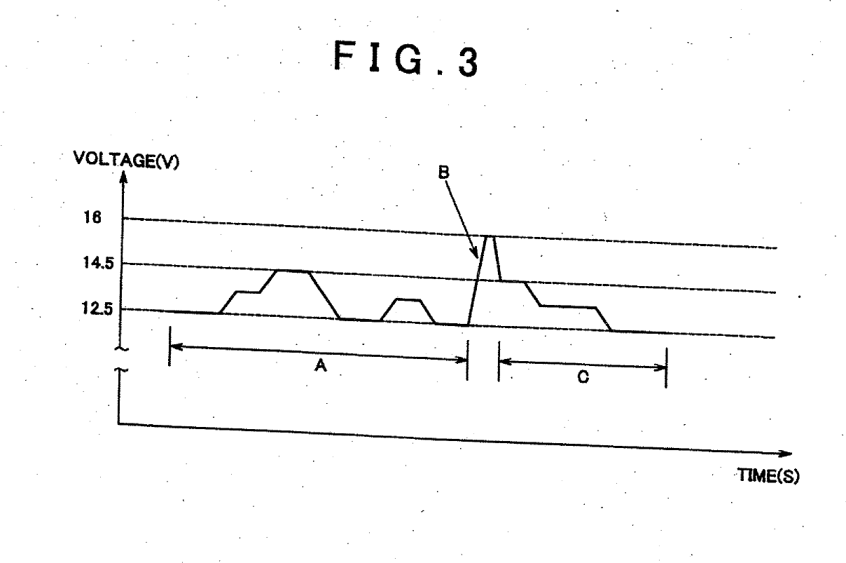

The operation of the power generation control device 1 of the first embodiment will be explained below. FIG. 2 is a flowchart illustrating the operation of the power generation control device 1. FIG. 3 illustrates how the voltage of the output terminals of the generator 4 is changed by the operation of the power generation control device 1.

On the supposition that the normal-power load 2 operates in the automobile but the high-power load 3 does not operate, the power generation voltage setting unit 6 sets the target value of the power generation voltage of the generator 4 to the first voltage V1 (step S1). The excitation current control unit 7 controls the excitation current of the generator 4 so that the power generation voltage of the generator 4 becomes the first voltage V1 (12.5 to 14.5 V) (step S2). As a result, the generator 4 generates the first voltage V1 (step S3). The power generation voltage at this time is the voltage within the interval A in FIG. 3.

On the supposition that the user then issues a command to start the high-power load 3 (step S4), for example, the user issues a command to start an EPS operation. As a result, the start warning unit 5 outputs a start warning signal before the high-power load 3 is started. The start warning signal is inputted to the power generation voltage setting unit 6 (step S5).

Where the power generation voltage setting unit 6 inputs the start warning signal, the power generation voltage setting unit outputs to the excitation current control unit 7 a signal (referred to hereinbelow as “V2 switching signal”) that indicates the switching of the target value of the power generation voltage from the first voltage V1 corresponding to the normal-power load 2 to the second voltage V2 that is higher than the first voltage V1 (step S6). The V2 switching signal is sent, for example, by parallel communication or by high-speed communication that indicates the switching by a one-bit signal. The second voltage V2 is taken, for example, as a rated voltage of a component receiving the power generation voltage. The rated voltage is, for example, 16 V.

Upon receiving the V2 switching signal, the excitation current control unit 7 controls the excitation current of the generator 4 so that the power generation voltage of the generator 4 becomes the second voltage V2 (step S7). The generator 4 generates the second voltage V2 (step S8). In this case, the power generation voltage is raised to the second voltage V2 (for example, 16 V), as shown by arrow B in FIG. 3. The excitation current control unit 7 sets the duty ratio of the switching regulator 10 to 1 till the power generation voltage becomes the second voltage V2. As a result, the generator 4 can perform power generation at full power generation capacity till the power generation voltage becomes the second voltage V2 and can rapidly increase the power generation voltage to the second voltage V2. Further, when the second voltage V2 is taken as a rated voltage of the component receiving the power generation voltage, if the power generation voltage exceeds the rated voltage of the component receiving the power generation voltage, an adverse effect can be produced on the component. Therefore, when the power generation voltage reaches the rated voltage, the excitation current control unit 7 decreases the duty ratio and prevents the power generation voltage from exceeding the rated voltage.

When the start of the high-power load 3 generates a rush current to the high-power load 3, the output terminal voltage (power generation voltage) of the generator 4 decreases as shown in FIG. 3. However, because the voltage decreases from the second voltage V2, the power generation control device 1 can prevent the power generation voltage from being less than 12.5 V.

At the point of time in which the rush current to the high-power load 3 attenuates and power consumption by the high-power load 3 decreases, the power generation voltage setting unit 6 outputs to the excitation current control unit 7 a signal (referred to hereinbelow as “V1 switching signal”) indicating the switching of the target value of excitation current control unit from the second voltage V2 to the first voltage V1 (step S9).

When the V1 switching signal is inputted, the excitation current control unit 7 controls the excitation current of the generator 4 so that the power generation voltage of the generator 4 becomes the first voltage V1 (step S10). As a result, the generator 4 generates the first voltage V1 (step S11). The power generation voltage at this time is a voltage within the interval C in FIG. 3. The operation of the power generation control device 1 is described above.

With the first embodiment, where the start warning unit 5 warns about the start of the high-power load 3 and the power generation voltage setting unit 6 receives the warning from the start warning unit 5, the power generation voltage setting unit switches the target value of the power generation voltage to a value for the high-power load 3. The excitation current control unit 7 performs the excitation current control corresponding to this switching. As a result, the power generation voltage can be raised to a value higher than the value corresponding to the normal-power load 2 before the high-power load 3 is started, and electronic devices and the like can be prevented from malfunctioning when the high-power load 3 is started.

In the example shown in FIG. 3, the second voltage V2 is set to 16 V, but this value is not limiting and the second voltage may be set, for example, to 15.5 V.

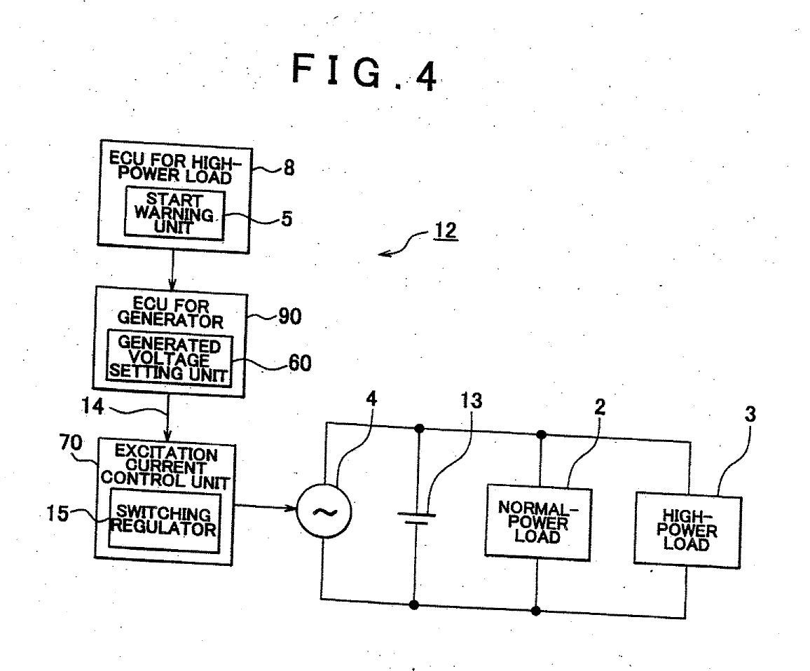

The power generation control device of the second embodiment of the invention will be described below with reference to the appended drawings. FIG. 4 shows the configuration of the power generation control device of the second embodiment. Components identical to those of the first embodiment are assigned with identical reference numerals and the explanation thereof is herein omitted.

A power generation control device 12 of the second embodiment controls a power generation voltage of a generator 4 that supplies power to a normal-power load 2 and a high-power load 3 that consumes more power than the normal-power load 2. The power generation control device 12 can be mainly applied to automobiles. The case in which the power generation control device 12 is applied to an automobile will be described below.

The difference between the second embodiment and the first embodiment is in a power generation voltage setting unit 60 and an excitation current control unit 70, other features of the second embodiment are identical to those of the first embodiment.

The power generation control device 12 includes a start warning unit 5, the power generation voltage setting unit 60, and the excitation current control unit 70.

The power generation voltage setting unit 60 sets a target value of the power generation voltage of a generator 4. The power generation voltage setting unit 60 is provided in an ECU 90 for a generator. Where it is preferred that no power be generated in order to reduce a drive load for driving the generator 4 with the object of reducing the engine load and improve acceleration ability of the vehicle, as in the case when the automobile accelerates, the power generation voltage setting unit 60 sets the target value of the power generation voltage to a first voltage V3 (for example, 12.5 V) that is lower than the positive electrode terminal reference voltage (for example, 12.8 V) of the battery 13 and, therefore, the generator 4 does not generate power. The power generation voltage setting unit 60 outputs a signal indicating the value of the first voltage V3 to the excitation current control unit 70, for example, by serial communication 14.

When the power generation voltage setting unit 60 inputs the start warning signal from the start warning unit 5, the power generation voltage setting unit switches the target voltage of the power generation voltage from the first voltage V3 (for example, 12.5 V) to a second voltage V4 (for example, 14.5 V) that is higher than the positive terminal reference voltage. The second voltage V4 is a voltage corresponding to positive power generation by power regenerative braking during automobile deceleration. The power generation voltage setting unit 60 outputs to the excitation current control unit 70 a signal (referred to hereinbelow as “V4 switching signal”) indicating the switching of the power generation voltage. Further, the power generation voltage setting unit 60 also outputs, for example, by serial communication 14, a signal (referred to hereinbelow as “V4 switching signal”) indicating the switching of the power generation voltage to the second voltage V4 to the excitation current control unit 70.

The excitation current control unit 70 controls the excitation current of the generator 4 so that the generator 4 does not generate power when the target value of the power generation voltage is the first voltage V3. When the excitation current control unit 70 inputs the V4 switching signal, the excitation current control unit controls the excitation current of the generator 4 so that the power generation voltage of the generator 4 becomes the second voltage V4.

The excitation current control unit includes a switching regulator 15 for controlling the excitation current. Where the target value of the power generation voltage is switched to the second voltage V4, it is preferred that the switching regulator 15 set the duty ratio to 1 till the power generation voltage becomes the second voltage V4. The generator 4 performs power generation at full power generation capacity as long as the duty ratio of the switching regulator 15 is 1. Therefore, the generator 4 can rapidly increase the power generation voltage to the second voltage V4.

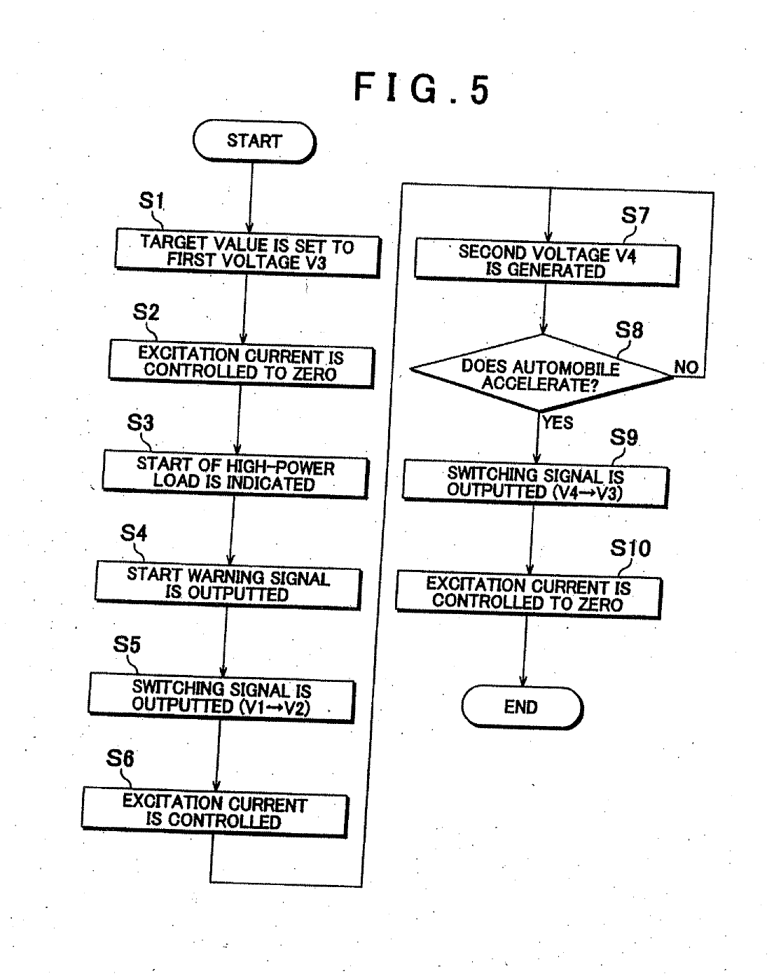

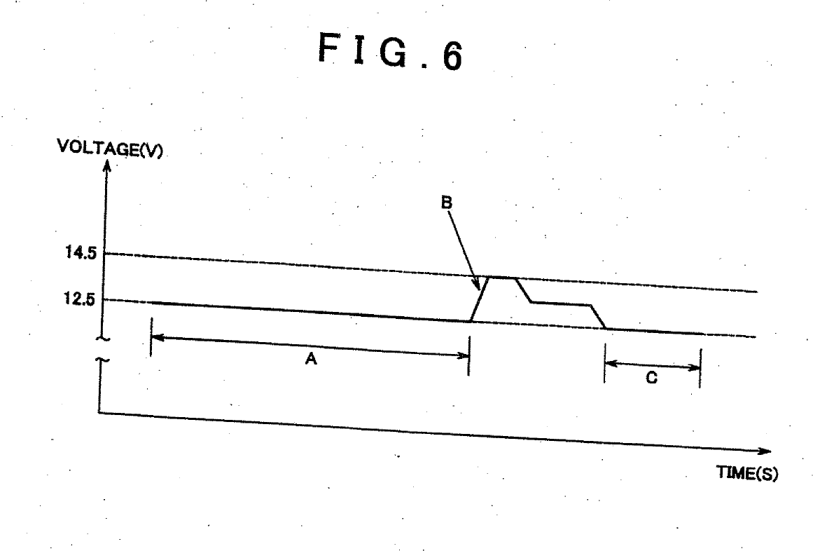

The operation of the power generation control device 12 of the second embodiment will be explained below. FIG. 5 is a flowchart illustrating the operation of the power generation control device 12. FIG. 6 illustrates how the voltage of the output terminals of the generator 4 is changed by the operation of the power generation control device 12.

Let us assume that the automobile is in the state of acceleration and the high-power load 3 does not operate. In this case, the power generation voltage setting unit 60 sets the target value of the power generation voltage of the generator 4 to the first voltage V3 (step S1). Because the first voltage V3 is lower than the positive electrode terminal reference voltage of the battery 13, the excitation current control unit 70 controls the excitation current of the generator 4 to zero so that the generator 4 does not generate power (step S2). In this case, the output terminal voltage of the generator 4 is the voltage within the interval A in FIG. 6.

Let us assume that the user then issues a command to start the high-power load 3 (step S3). The acceleration state of the automobile is assumed to be maintained. The indication to start the high-power load 3 is, for example, the start of an EPS operation. Accordingly, the start warning unit 5 outputs a start warning signal before the high-power load 3 is started. The start warning signal is inputted in the power generation voltage setting unit 60 (step S4).

Where the power generation voltage setting unit 60 inputs the start warning signal, the power generation voltage setting unit switches the target voltage of the power generation voltage from the first voltage V3 to the second voltage V4 that is higher than the positive electrode terminal reference voltage. The power generation voltage setting unit 60 outputs a signal (referred to hereinbelow as “V4 switching signal”) indicating the switching of the power generation voltage to the excitation current control unit 70 (step S5). The V4 switching signal is sent, for example, by serial communication 14, but it may be also sent by parallel communication or by communication that indicates the switching by a one-bit signal.

When the excitation current control unit 70 inputs the V4 switching signal, the excitation current control unit controls the excitation current of the generator 4 so that the power generation voltage of the generator 4 becomes the second voltage V4 (step S6). As a result, the generator 4 generates the second voltage V4 (step S7). In this case, the power generation voltage rises to the second voltage V4 (for example, 14.5 V) as shown by an arrow B in FIG. 6.

When the duty ratio of the switching regulator 15 is set to 1 in the excitation current control unit 70 till the power generation voltage becomes the second voltage V4, the generator 4 generates power at full power generation capacity till the power generation voltage becomes the second voltage V4. In this case, the generator 4 can rapidly increase the power generation voltage to the second voltage V4.

When the start of the high-power load 3 generates a rush current to the high-power load 3, the output terminal voltage (power generation voltage) of the generator 4 decreases as shown in FIG. 6. However, because the voltage decreases from the second voltage V4, the power generation control device 12 can prevent the power generation voltage from being less than 12.5 V.

After the rush current to the high-power load 3 attenuates and power consumption by the high-power load 3 decreases, a central processing unit (CPU), which is not shown in the figure, determines whether the automobile accelerates (step S8). Where it is determined that the automobile accelerates, the power generation voltage setting unit 60 outputs to the excitation current control unit 70 a signal (V3 switching signal) indicating the switching of the target value of the power generation voltage from the second voltage V4 to the first voltage V3 (step S9). Because the first voltage V3 is lower than the positive electrode terminal reference voltage of the battery 13, the excitation current control unit 70 controls the excitation current of the generator 4 to zero so that the generator 4 does not generate power (step S10). In this case, the output terminal voltage of the generator 4 is the voltage within the interval C in FIG. 6. On the other hand, when it is determined that the automobile decelerates, the processing flow returns to step S7 and the second voltage V4 is thereafter generated. The operation of the power generation control device 12 is described above.

With the second embodiment, where the start warning unit 5 warns about the start of the high-power load 3 and the power generation voltage setting unit 60 receives the warning from the start warning unit 5, the power generation voltage setting unit switches the target value of the power generation voltage to a second voltage V4 that is higher than the positive electrode terminal reference voltage of the battery 13. The excitation current control unit 70 performs the excitation current control correspondingly to this switching. As a result, for example, even when the generator 4 installed on the automobile stops power generation when the automobile accelerates, the generator can immediately start power generation in response to the warning about the start of the power load 3 and can generate power of a voltage higher than the positive electrode terminal voltage of the battery 13 before the power load 3 is started. Therefore, the power generation control device 12 can prevent electronic devices and the like from malfunctioning when the high-power load 3 is started during automobile acceleration.

In the examples shown in FIGS. 4 to 6, the case is explained in which the high-power load 3 is started when the automobile accelerates, but the generated power may be also switched by a similar method in the case where the usual power load 2 is started when the automobile accelerates. Further, in the example shown in FIG. 6, the second voltage V4 is set to 14.5 V, but this value is not limiting and the second voltage may be set to a higher voltage (for example, 16 V). Further, even in the case when high power consumption occurs in a stationary state (for example, during idling) that is neither acceleration nor deceleration, the power generation voltage may be controlled by the same method as in the above-described case of acceleration.

The invention is mainly useful as a device for adequately controlling the power generation voltage of a generator installed on an automobile.

While the invention has been described with reference to example embodiments thereof, it is to, be understood that the invention is not limited to the described embodiments or constructions. To the contrary, the invention is intended to cover various modifications and equivalent arrangements. In addition, while the various elements of the disclosed invention are shown in various example combinations and configurations, other combinations and configuration, including more, less or only a single element, are also within the scope of the appended claims.

1. A power generation control device that controls a power generation voltage of a generator that supplies power to a normal-power load and a high-power load that consumes more power than the normal-power load, the power generation control device comprising:
a start warning unit that warns about a start of the high-power load;
a power generation voltage setting unit that sets a target value of the power generation voltage of the generator and switches the target value from a first voltage corresponding to the normal-power load to a second voltage that is higher than the first voltage when a warning is received from the start warning unit; and
an excitation current control unit that controls an excitation current of the generator so that the power generation voltage of the generator becomes the first voltage when the target voltage is the first voltage, and controls the excitation current of the generator so that the power generation voltage of the generator becomes the second voltage when the target value is switched to the second voltage.

2. The power generation control device according to claim 1, wherein the second voltage corresponds to the voltage supplied to the normal power load added to the high-power load.

3. The power generation control device according to claim 1, wherein the high-power load is an electric power steering, and the start warning unit warns about the start of the high-power load when a command to start the electric power steering is issued.

4. The power generation control device according to claim 1, wherein the excitation current control unit comprises a switching regulator that controls the excitation current, and when the target value is switched to the second voltage, the switching regulator sets a duty ratio to 1 till the power generation voltage becomes the second voltage.

5. The power generation control device according to claim 1, wherein the second voltage is a rated voltage of a component receiving the power generation voltage.

6. The power generation control device according to claim 4, wherein the excitation current control unit makes the duty ratio less than 1 when the power generation voltage becomes the second voltage and controls the excitation current of the generator so that the power generation voltage does not exceed the second voltage.

7. A power generation control device that controls a power generation voltage of a generator that supplies power to a power load, comprising:
a start warning unit that warns about a start of the power load;
a power generation voltage setting unit that sets a target value of the power generation voltage of the generator and switches the target value from a first voltage that is lower than a positive electrode terminal reference voltage of a battery connected to the generator to a second voltage that is higher than the positive electrode terminal reference voltage when a warning is received from the start warning unit; and
an excitation current control unit that controls an excitation current of the generator so that the generator does not perform power generation when the target value is the first voltage and also controls an excitation current of the generator so that the power generation voltage of the generator becomes the second voltage when the target value is switched to the second voltage.

8. The power generation control device according to claim 7, wherein the excitation current control unit comprises a switching regulator for controlling the excitation current, and when the target value is switched to the second voltage, the switching regulator sets a duty ratio to 1 till the power generation voltage becomes the second voltage.

9. A vehicle equipped with the power generation control device according to claim 1, comprising:
an acceleration state detection unit that detects an acceleration state of the vehicle, wherein the power generation voltage setting unit sets a voltage at the time the acceleration state detection unit detects that the vehicle is in an acceleration state to a lower limit value of the first voltage, and sets a voltage at the time the acceleration state detection unit detects that the vehicle is in a deceleration state to an upper limit value of the first voltage.

10. A vehicle equipped with the power generation control device according to claim 1, comprising:
an acceleration state detection unit that detects an acceleration state of the vehicle, wherein the excitation current control unit controls the excitation current of the generator to zero when the acceleration state detection unit detects that the vehicle is in the acceleration state and the start warning unit does not warn about the start of the high-power load.

11. A method for controlling a power generation voltage of a generator that supplies power to a normal-power load and a high-power load that consumes more power than the normal-power load, the method comprising:
warning about a start of the high-power load;
switching a target value of the power generation voltage of the generator from a first voltage corresponding to the normal-power load to a second voltage that is higher than the first voltage when a warning about the start of the high-power load is issued; and
controlling an excitation current of the generator so that the power generation voltage of the generator becomes the first voltage when the target voltage is the first voltage, and controlling an excitation current of the generator so that the power generation voltage of the generator becomes the second voltage when the target value is switched to the second voltage.

12. A method for controlling a power generation voltage of a generator that supplies power to a power load, the method comprising:
warning about a start of the high-power load;
setting a target value of the power generation voltage of the generator;
switching the target value for generator power transmission from a first voltage that is lower than a positive electrode terminal reference voltage of a battery connected to the generator to a second voltage that is higher than the positive electrode terminal reference voltage; and
controlling an excitation current of the generator so that the generator does not perform power generation when the target value is the first voltage and also controlling an excitation current of the generator so that the power generation voltage of the generator becomes the second voltage when the target value is switched to the second voltage.

13. The vehicle equipped with the power generation control device according to claim 7, comprising:
an acceleration state detection unit that detects an acceleration state of the vehicle, wherein the excitation current control unit controls the excitation current of the generator to zero when the acceleration state detection unit detects that the vehicle is in the acceleration state and the start warning unit does not warn about the start of the high-powered load.
